(19) United States
(12) Patent Application Publication
(10) Pub. No.: US 2010/0045533 A1
(43) Pub. Date: Feb. 25, 2010

(54) DUAL-POLARIZED ANTENNA

(75) Inventor: Mu-Kun Hsueh, Kaohsiung City (TW)

Correspondence Address: STEVENS & SHOWALTER LLP, 7019 CORPORATE WAY, DAYTON, OH, 45459-4238, US

(73) Assignee: SmartAnt Telecom Co., Ltd., Hsinchu County (TW)

(21) Appl. No.: 12/241,587

(22) Filed: Sep. 30, 2008

(30) Foreign Application Priority Data
Aug. 20, 2008 (TW) 097214955

(51) Int. Cl. H01Q 1/38

(52) U.S. Cl. 343/700 MS

(57) ABSTRACT

A dual-polarized antenna device includes a base plate, a first polarized antenna, and a second polarized antenna. The second polarized antenna is arranged perpendicularly crossing the first polarized antenna without contact. The first polarized antenna and the second polarized antenna are respectively connected to the base plate integrally and inseparably, such that the dual-polarized antenna device has a reduced cost and is more convenient to assemble.

### CROSS-REFERENCE TO RELATED APPLICATIONS

This non-provisional application claims priority under 35 U.S.C. §119(a) on Patent Application No(s). 097214955 filed in Taiwan, R.O.C. on Aug. 20, 2008 the entire contents of which are hereby incorporated by reference.

### BACKGROUND

1. Field of Invention

The present invention relates to an antenna device, and more particularly to a dual-polarized antenna device.

2. Related Art

A radio frequency (RF) signal output by a radio transmitter is transmitted to an antenna through a feeder, and then radiated out in the form of an electromagnetic wave by the antenna. When transmitted to a receiving point, the electromagnetic wave is received by an antenna, and then the RF signal is transmitted to a radio receiver through a feeder.

Generally, an antenna radiates electromagnetic waves to its surroundings. The electromagnetic wave is composed of an electric field and a magnetic field, in which the direction of the electric field is a polarization direction of the antenna. Therefore, the electromagnetic waves that can be received and radiated by antennae having different polarization characteristics vary with different polarization directions.

The structural design of the antenna is quite complicated and involves considerations of antenna gain, impedance matching, dimension, and so on, such that the manufacturing and assembly of the antenna appear quite difficult. Therefore, in order to effectively simplify the manufacturing and assembly processes of the antenna as well as reduce the manufacturing cost thereof, related researchers continuously improve the structural design of the antenna.

### SUMMARY OF THE INVENTION

Accordingly, the present invention is directed to a dual-polarized antenna device, so as to solve the problem in the prior art that the structure of an antenna is generally complicated and thus results in difficulties in the manufacturing and assembly thereof.

A dual-polarized antenna device including a base plate, a first polarized antenna, and a second polarized antenna is provided.

The first polarized antenna includes a first radiation portion, a first support portion, a first ground portion, and a second support portion. The second polarized antenna includes a second radiation portion, a third support portion, a second ground portion, and a fourth support portion. The second polarized antenna is arranged perpendicularly crossing the first polarized antenna without contact.

The first radiation portion is used for receiving/transmitting an electromagnetic wave. The first support portion is integrally and inseparably connected between the base plate and the first radiation portion, and is used to support the first radiation portion. The first ground portion is arranged with and extending along the first radiation portion, and is used to be grounded. The second support portion is connected between the base plate and the first ground portion integrally and inseparably, and is use to support the first ground portion. The second radiation portion is used for receiving/transmitting the electromagnetic wave. The third support portion is integrally and inseparably connected between the base plate and the second radiation portion, and is used to support the second radiation portion. The second ground portion is arranged with and extending along the second radiation portion, and is used to be grounded. The fourth support portion is integrally and inseparably connected between the base plate and the second ground portion, and is used to support the second ground portion.

The dual-polarized antenna device further includes a metal plate disposed on the face of the base plate opposite to the first polarized antenna and the second polarized antenna.

Moreover, the dual-polarized antenna device further includes a first coaxial cable and a second coaxial cable penetrating the base plate. The first coaxial cable includes a first feeding line, a first insulating layer, and a first metal layer. The second coaxial cable includes a second feeding line, a second insulating layer, and a second metal layer.

The first feeding line is connected to the first radiation portion so as to transmit an electrical signal corresponding to the electromagnetic wave. The first insulating layer having insulating properties is wrapped around the first feeding line. The first metal layer is wrapped around the first insulating layer and connected to the first ground portion. The second feeding line is connected to the second radiation portion so as to transmit the electrical signal corresponding to the electromagnetic wave. The second insulating layer having insulating properties is wrapped around the second feeding line. The second metal layer is wrapped around the second insulating layer and connected between the second ground portion and the fourth support portion.

A surface of the first radiation portion extends to intersect with a surface of the base plate, and a surface of the first ground portion extends to intersect with the surface of the base plate. A surface of the second radiation portion extends to intersect with the surface of the base plate, and a surface of the second ground portion extends to intersect with the surface of the base plate.

In addition, the base plate has a first through-hole located between the first support portion and the second support portion and a second through-hole located between the third support portion and the fourth support portion. The dual-polarized antenna device further includes a first coaxial cable and a second coaxial cable. The first coaxial cable is electrically connected to the first radiation portion and the first ground portion through the first through-hole. The second coaxial cable is electrically connected to the second radiation portion and the second ground portion through the second through-hole.

In view of the above, in the present invention, through the respective integral and inseparable connections of the first polarized antenna and the second polarized antenna to the base plate, the dual-polarized antenna device has a reduced cost and is more convenient to assemble.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a dual-polarized antenna device according to a first embodiment of the present invention;

FIG. 2 is a schematic view of a first polarized antenna in FIG. 1;

FIG. 3 is a schematic view of a second polarized antenna in FIG. 1;

FIG. 4 is a schematic view of a dual-polarized antenna device according to a second embodiment of the present invention;

FIG. 5 is a schematic view of a dual-polarized antenna device according to a third embodiment of the present invention;

FIG. 6 is a schematic enlarged view of a first polarized antenna in a circled part of FIG. 5;

FIG. 7 is a schematic enlarged view of a second polarized antenna in the circled part of FIG. 5;

FIG. 8 is a curve diagram illustrating an isolation test between the first polarized antenna and the second polarized antenna shown in FIG. 5;

FIG. 9 is a curve diagram illustrating a test of a standing wave ratio (SWR) on a first coaxial cable shown in FIG. 5;

FIG. 10 is a curve diagram illustrating a test of an SWR measured on a second coaxial cable shown in FIG. 5;

FIG. 11A is a radiation pattern of a horizontal plane (H-plane) at a measured frequency of 2.3 GHz after the second coaxial cable of the antenna shown in FIG. 5 feeds a signal;

FIG. 11B is a radiation pattern of a H-plane at a measured frequency of 2.4 GHz after the second coaxial cable of the antenna shown in FIG. 5 feeds the signal;

FIG. 11C is a radiation pattern of a H-plane at a measured frequency of 2.5 GHz after the second coaxial cable of the antenna shown in FIG. 5 feeds the signal;

FIG. 11D is a radiation pattern of a H-plane at a measured frequency of 2.6 GHz after the second coaxial cable of the antenna shown in FIG. 5 feeds the signal;

FIG. 11E is a radiation pattern of a H-plane at a measured frequency of 2.7 GHz after the second coaxial cable of the antenna shown in FIG. 5 feeds the signal;

FIG. 12A is a radiation pattern of a vertical plane (V-plane) at the measured frequency of 2.3 GHz after the second coaxial cable of the antenna shown in FIG. 5 feeds the signal;

FIG. 12B is a radiation pattern of an V-plane at the measured frequency of 2.4 GHz after the second coaxial cable of the antenna shown in FIG. 5 feeds the signal;

FIG. 12C is a radiation pattern of an V-plane at the measured frequency of 2.5 GHz after the second coaxial cable of the antenna shown in FIG. 5 feeds the signal;

FIG. 12D is a radiation pattern of an V-plane at the measured frequency of 2.6 GHz after the second coaxial cable of the antenna shown in FIG. 5 feeds the signal;

FIG. 12E is a radiation pattern of an V-plane at the measured frequency of 2.7 GHz after the second coaxial cable of the antenna shown in FIG. 5 feeds the signal;

FIG. 13A is a radiation pattern of a H-plane at the measured frequency of 2.3 GHz after the first coaxial cable of the antenna shown in FIG. 5 feeds a signal;

FIG. 13B is a radiation pattern of a H-plane at the measured frequency of 2.4 GHz after the first coaxial cable of the antenna shown in FIG. 5 feeds the signal;

FIG. 13C is a radiation pattern of a H-plane at a measured frequency of 2.5 GHz after the first coaxial cable of the antenna shown in FIG. 5 feeds a signal;

FIG. 13D is a radiation pattern of a H-plane at the measured frequency of 2.6 GHz after the first coaxial cable of the antenna shown in FIG. 5 feeds the signal;

FIG. 13E is a radiation pattern of a H-plane at the measured frequency of 2.7 GHz after the first coaxial cable of the antenna shown in FIG. 5 feeds the signal;

FIG. 14A is a radiation pattern of an V-plane at the measured frequency of 2.3 GHz after the first coaxial cable of the antenna shown in FIG. 5 feeds the signal;

FIG. 14B is a radiation pattern of an V-plane at the measured frequency of 2.4 GHz after the first coaxial cable of the antenna shown in FIG. 5 feeds the signal;

FIG. 14C is a radiation pattern of an V-plane at the measured frequency of 2.5 GHz after the first coaxial cable of the antenna shown in FIG. 5 feeds the signal;

FIG. 14D is a radiation pattern of an V-plane at the measured frequency of 2.6 GHz after the first coaxial cable of the antenna shown in FIG. 5 feeds the signal; and

FIG. 14E is a radiation pattern of an V-plane at the measured frequency of 2.7 GHz after the first coaxial cable of the antenna shown in FIG. 5 feeds the signal.

### DETAILED DESCRIPTION OF THE INVENTION

The detailed features and advantages of the present invention will be described in detail in the following embodiments. Those skilled in the arts can easily understand and implement the content of the present invention. Furthermore, the relative objectives and advantages of the present invention are apparent to those skilled in the arts with reference to the content disclosed in the specification, claims, and drawings. The embodiments below are intended to further describe the views of the present invention instead of limiting the scope of the same.

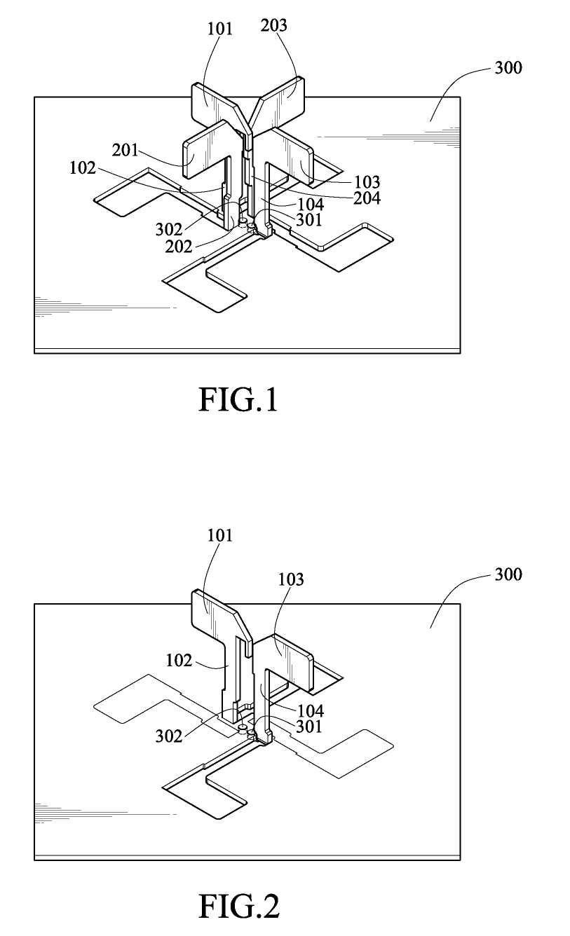

FIG. 1 is a schematic view of a dual-polarized antenna device according to an embodiment of the present invention. In this embodiment, the dual-polarized antenna device includes a base plate 300, a first polarized antenna 100, and a second polarized antenna 200. The second polarized antenna 200 is arranged perpendicularly crossing the first polarized antenna 100 without contact.

FIG. 2 is a schematic view of a first polarized antenna according to an embodiment of the present invention. Herein, in order to facilitate the illustration, the second polarized antenna 200 is not shown in FIG. 2

Referring to FIGS. 1 and 2, the first polarized antenna 100 includes a first radiation portion 101, a first support portion 102, a first ground portion 103, and a second support portion 104.

The first support portion 102 is connected between the base plate 300 and the first radiation portion 101. The second support portion 104 is connected between the base plate 300 and the first ground portion 103.

The first support portion 102 has one end joined to a bottom side of the first radiation portion 101 and the other end joined to the base plate 300. Moreover, the second support portion 104 has one end joined to a bottom side of the first ground portion 103 and the other end joined to the base plate 300. The first support portion 102 and the second support portion 104 are disposed adjacent to each other on the base plate 300, i.e., the first support portion 102 and the second support portion 104 are spaced by a first set distance from each other. Further, the first radiation portion 101 and the first ground portion 103 respectively extend from the first support portion 102 and the second support portion 104 in opposite directions and expand into planes.

Herein, the first radiation portion 101 may be a metal sheet completely in the same plane, and the first ground portion 103 may also be another metal sheet completely in the same plane. The first ground portion 103 and the first radiation portion 101 extend to be arranged. In other words, the first ground portion 103 and the first radiation portion 101 are approximately coplanar.

In addition, a surface of the first radiation portion 101 extends to intersect with a surface of the base plate 300, and a surface of the first ground portion 103 extends to intersect with the surface of the base plate 300. The first support portion 102 and the second support portion 104 are approximately perpendicularly connected to the base plate 300, and the first ground portion 103 and the first radiation portion 101 are approximately coplanar.

Herein, the first radiation portion 101, the first support portion 102, and the base plate 300 may be integrally formed. That is, a metal plate may be used as the base plate 300. Moreover, the first radiation portion 101 and the first support portion 102 connected to each other are cut out of the metal plate, and the side of the first support portion 102 opposite to the side connected to the first radiation portion 101 is uncut so as to be joined to the base plate 300. Then, the cut-out first radiation portion 101 and first support portion 102 are erected on the base plate 300 through a joint between the first support portion 102 and the base plate 300.

Similarly, the first ground portion 103, the second support portion 104, and the base plate 300 may also be integrally formed. That is, a metal plate may be used as the base plate 300. Moreover, the first ground portion 103 and the second support portion 104 connected to each other are cut out of the metal plate, and the side of the second support portion 104 opposite to the side connected to the first ground portion 103 is uncut so as to be joined to the base plate 300. Then, the cut-out first ground portion 103 and second support portion 104 are erected on the base plate 300 through a joint between the second support portion 104 and the base plate 300.

Herein, the first radiation portion 101 is used for receiving/transmitting an electromagnetic wave. The first support portion 102 supports the first radiation portion 101. The first ground portion 103 is used for grounding. The second support portion 104 supports the first ground portion 103.

The base plate 300 has a first through-hole 301 located between the first support portion 102 and the second support portion 104. A signal line may pass through the first through-hole 301 from the side of the base plate 300 opposite to the side disposed with the first support portion 102 and the second support portion 104, and is then connected to the first radiation portion 101 and the first ground portion 103. In other words, the first through-hole 301 allows a signal line to pass through.

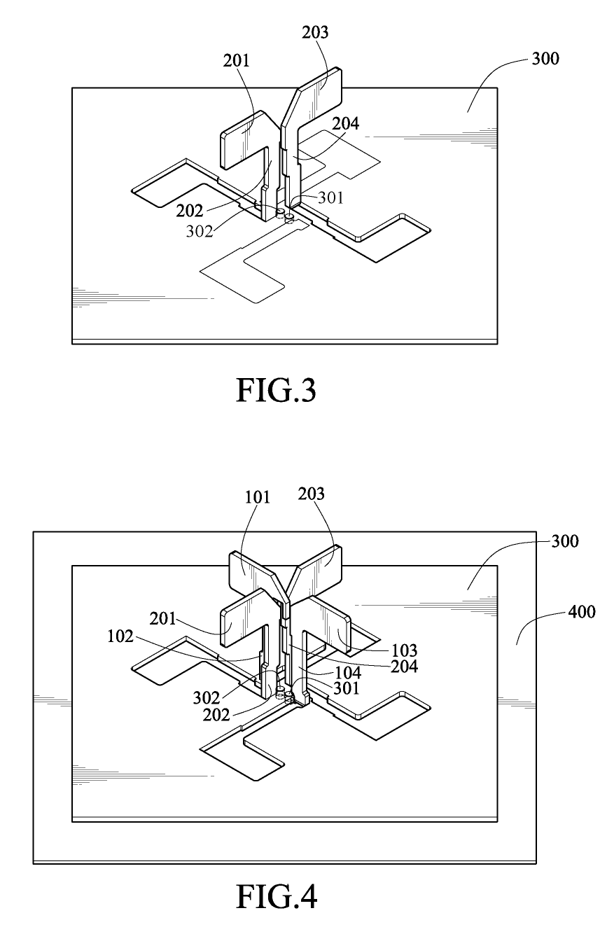

FIG. 3 is a schematic view of a second polarized antenna according to an embodiment of the present invention. Herein, in order to facilitate the illustration, the first polarized antenna 100 is not shown in FIG. 3.

Referring to FIGS. 1 and 3, the second polarized antenna 200 includes a second radiation portion 201, a third support portion 202, a second ground portion 203, and a fourth support portion 204.

The third support portion 202 is connected between the base plate 300 and the second radiation portion 201. The fourth support portion 204 is connected between the base plate 300 and the second ground portion 203.

The third support portion 202 has one end joined to a bottom side of the second radiation portion 201 and the other end joined to the base plate 300. Moreover, the fourth support portion 204 has one end joined to a bottom side of the second ground portion 203 and the other end joined to the base plate 300. The third support portion 202 and the fourth support portion 204 are disposed adjacent to each other on the base plate 300, i.e., the third support portion 202 and the fourth support portion 204 are spaced by the first set distance from each other. Further, the second radiation portion 201 and the second ground portion 203 respectively extend from the third support portion 202 and the fourth support portion 204 in opposite directions and expand into planes.

Herein, the second radiation portion 201 may be a metal sheet completely in the same plane, and the second ground portion 203 may also be another metal sheet completely in the same plane. The second ground portion 203 and the second radiation portion 201 extend to be arranged. In other words, the second ground portion 203 and the second radiation portion 201 are approximately coplanar.

In addition, a surface of the second radiation portion 201 extends to intersect with a surface of the base plate 300, and a surface of the second ground portion 203 extends to intersect with the surface of the base plate 300. The third support portion 202 and the fourth support portion 204 are approximately perpendicularly connected to the base plate 300, and the second radiation portion 201 and the second ground portion 203 are approximately coplanar.

Herein, the second radiation portion 201, the third support portion 202, and the base plate 300 may be integrally formed. That is, a metal plate may be used as the base plate 300. Moreover, the second radiation portion 201 and the third support portion 202 connected to each other are cut out of the metal plate, and the side of the third support portion 202 opposite to the side connected to the second radiation portion 201 is uncut so as to be joined to the base plate 300. Then, the cut-out second radiation portion 201 and third support portion 202 are erected on the base plate 300 through a joint between the third support portion 202 and the base plate 300.

Similarly, the second ground portion 203, the fourth support portion 204, and the base plate 300 may also be integrally formed. That is, a metal plate may be used as the base plate 300. Moreover, the second ground portion 203 and the fourth support portion 204 connected to each other are cut out of the metal plate, and the side of the fourth support portion 204 opposite to the side connected to the second ground portion 203 is uncut so as to be joined to the base plate 300. Then, the cut-out second ground portion 203 and fourth support portion 204 are erected on the base plate 300 through a joint between the fourth support portion 204 and the base plate 300.

Herein, the second radiation portion 201 is used for receiving/transmitting an electromagnetic wave. The third support portion 202 supports the second radiation portion 201. The second ground portion 203 is used for grounding. The fourth support portion 204 supports the second ground portion 203.

The base plate 300 has a second through-hole 302 located between the third support portion 202 and the fourth support portion 204. A signal line may pass through the second through-hole 302 from the side of the base plate 300 opposite to the side disposed with the third support portion 202 and the fourth support portion 204, and is then connected to the second radiation portion 201 and the second ground portion 203. In other words, the second through-hole 302 allows another signal line to pass through.

Referring to FIG. 4, a metal plate 400 is disposed on the face of the base plate 300 opposite to the first polarized antenna 100 and the second polarized antenna 200, so as to enhance the strength of the signal. That is, a surface of the metal plate 400 contacts the surface of the base plate 300 opposite to the first polarized antenna 100 and the second polarized antenna 200.

In an embodiment, the base plate, the first polarized antenna 100, and the second polarized antenna 200 are made of a single metal plate. In other words, the first radiation portion 101 and the first support portion 102 connected to each other, the first ground portion 103 and the second support portion 104 connected to each other, the second radiation portion 201 and the third support portion 202 connected to each other, and the second ground portion 203 and the fourth support portion 204 connected to each other are cut out at corresponding positions of the metal plate. Moreover, the sections of the first support portion 102, the second support portion 104, the third support portion 202, and the fourth support portion 204 respectively opposite to the first radiation portion 101, the first ground portion 103, the second radiation portion 201, and the second ground portion 203 are uncut, i.e., remain joined to the rest part of the metal plate. Then, the cut-out first radiation portion 101 and first support portion 102 are erected on the rest part of the metal plate through the first support portion, the cut-out first ground portion 103 and second support portion 104 are erected on the rest part of the metal plate through the second support portion 104, the cut-out second radiation portion 201 and third support portion 202 are erected on the rest part of the metal plate through the third support portion 202, and the cut-out second ground portion 203 and fourth support portion 204 are erected on the rest part of the metal plate through the fourth support portion 204. Therefore, the base plate 300 defined with a first opening 303, a second opening 304, a third opening 305, and a fourth opening 306 is formed. The first opening 303, the second opening 304, the third opening 305, and the fourth opening 306 are correspondingly formed after the first polarized antenna 100 and the second polarized antenna 200 are cut out of the metal plate and erected, and the remaining part of the metal plate is used as the base plate 300. At this point, the metal plate 400 contacting the base plate 300 may further be employed to cover (shield) the first opening 303, the second opening 304, the third opening 305, and the fourth opening 306, so as to enhance the directivity of the radiated signal resulted from the base plate 300.

Herein, the shape of the first opening 303 may be completely the same as that of the first radiation portion 101 and the first support portion 102, or similar to but larger than that of the first radiation portion 101 and the first support portion 102. That is, a metal block similar to but larger than the shape of the first radiation portion 101 and the first support portion 102 is approximately cut out of the metal plate, and then the cut-out metal block is fine adjusted to be tailored into the required shape of the first radiation portion 101 and the first support portion 102, so as to obtain the first radiation portion 101 and the first support portion 102. Likewise, the shape of the second opening 304 may be completely the same as that of the first ground portion 103 and the second support portion 104, or similar to but larger than that of the first ground portion 103 and the second support portion 104. The shape of the third opening 305 may be completely the same as that of the second radiation portion 201 and the third support portion 202, or similar to but larger than that of the second radiation portion 201 and the third support portion 202. The shape of the fourth opening 306 may be completely the same as that of the second ground portion 203 and the fourth support portion 204, or similar to but larger than that of the second ground portion 203 and the fourth support portion 204.

Moreover, the first through-hole 301 and the second through-hole 302 may be disposed and both penetrate the base plate 300 and the metal plate 400, so as to allow the signal lines to pass through.

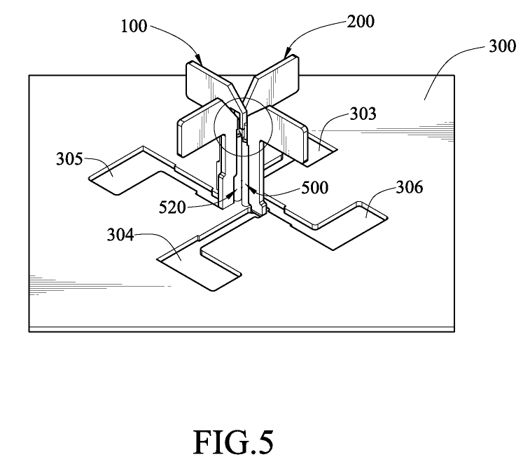

Referring to FIG. 5, a first coaxial cable 500 and a second coaxial cable 520 are respectively electrically connected to the first polarized antenna 100 and the second polarized antenna 200, so as to respectively transmit the signal of the first polarized antenna 100 and the signal of the second polarized antenna 200.

The first coaxial cable 500 and the second coaxial cable 520 penetrate the base plate 300 and are respectively connected to the first polarized antenna 100 and the second polarized antenna 200.

The first coaxial cable 500 has one end connected to the first polarized antenna 100 and the other end connected to a related circuit of an electronic device, such that an electrical signal from the related circuit of the electronic device may be transmitted to the first polarized antenna 100 through the first coaxial cable 500 so as to be wirelessly radiated out, and an electrical signal wirelessly received by the first polarized antenna 100 may be transmitted to the related circuit of the electronic device through the first coaxial cable 500. The second coaxial cable 520 has one end connected to the second polarized antenna 200 and the other end connected to the related circuit of the electronic device, such that an electrical signal from the related circuit of the electronic device may be transmitted to the second polarized antenna 200 through the second coaxial cable 520 so as to be wirelessly radiated out, and an electrical signal wirelessly received by the second polarized antenna 200 may be transmitted to the related circuit of the electronic device through the second coaxial cable 520.

The base plate 300 is defined with the first through-hole 301 and the second through-hole 302, and the first coaxial cable 500 and the second coaxial cable 520 respectively pass through the first through-hole 301 and the second through-hole 302.

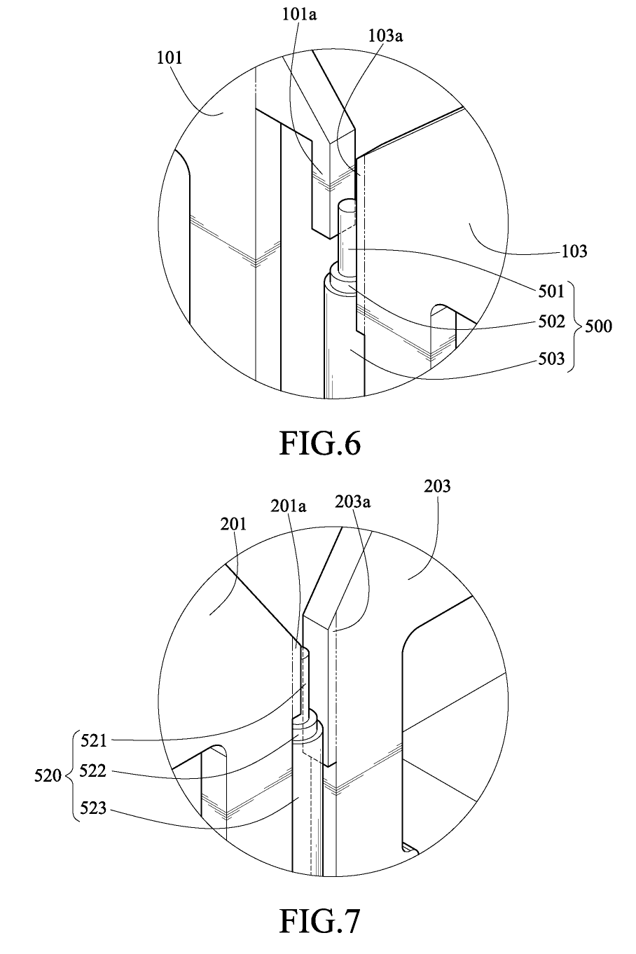

FIG. 6 is an enlarged view of a circled block in FIG. 5. Herein, in order to facilitate the illustration, the second polarized antenna 200 and the second coaxial cable 520 are not shown in FIG. 6.

Referring to FIGS. 5 and 6, the first coaxial cable 500 includes a first feeding line 501, a first insulating layer 502, and a first metal layer 503.

The first insulating layer 502 is wrapped around an outer surface of the first feeding line 501. The first metal layer 503 is wrapped around an outer surface of the first insulating layer 502. The first insulating layer 502 having insulating properties electrically isolates the first feeding line 501 from the first metal layer 503.

The first feeding line 501 has one end connected to the first radiation portion 101 and the other end connected to the related circuit of the electronic device (not shown). The first metal layer 503 has one end connected to the first ground portion 103 and the other end connected to a ground of the related circuit of the electronic device (not shown).

The first feeding line 501 transmits an electrical signal corresponding to the electromagnetic wave received by the first radiation portion 101 to the related circuit of the electronic device, and then the related circuit of the electronic device transmits the electrical signal to the first radiation portion 101, such that the first radiation portion 101 converts the electrical signal and sends out the electromagnetic wave corresponding to the electrical signal.

Herein, the first coaxial cable 500 passes through the base plate 300 and penetrates the base plate 300 from between the first support portion 102 and the second support portion 104.

The first radiation portion 101 is defined with a protruding portion 101a. The protruding portion 101a extends from the first radiation portion 101, and a distal end of the protruding portion 101a is joined to the first feeding line 501 but spaced from the first metal layer 503 (i.e., without contacting the first metal layer 503). In other words, the protruding portion 101a is integrally and inseparably disposed on the first radiation portion 101 and has conductive properties, such that the first radiation portion 101 and the first feeding line 501 are electrically conducted through the protruding portion 101a.

The protruding portion 101a extends from the first radiation portion 101 in a direction towards the first ground portion 103, but is spaced from the first ground portion 103 and the first metal layer 503 (i.e., without contacting the first ground portion 103 and the first metal layer 503). The distal end of the protruding portion 101a is directed to the base plate 300, so as to be joined to the first feeding line 501 penetrating the base plate 300. Herein, the protruding portion 101a may extend in an L shape.

That is, the protruding portion 101a does not contact the first metal layer 503 nor contact the first ground portion 103.

In addition, the first ground portion 103 may also be defined with a protruding portion 103a. The protruding portion 103a extends from the first ground portion 103, and the first ground portion 103 is joined to the first metal layer 503 but spaced from the first feeding line 501 (i.e., without contacting the first feeding line 501). In other words, the protruding portion 103a is integrally and inseparably disposed on the first ground portion 103 and has conductive properties, such that the first ground portion 103 and the first metal layer 503 are electrically conducted through the protruding portion 103a.

The protruding portion 103a extends from the first ground portion 103 in a direction towards the first radiation portion 101, but is spaced from the same (i.e., without contacting the first radiation portion 101).

That is, the protruding portion 103a does not contact the first feeding line 501 nor contact the first radiation portion 101.

FIG. 7 is an enlarged view of the circled block in FIG. 5. Herein, in order to facilitate the illustration, the first polarized antenna 100 and the first coaxial cable 500 are not shown in FIG. 7.

Referring to FIGS. 5 and 7, the second coaxial cable 520 includes a second feeding line 521, a second insulating layer 522, and a second metal layer 523.

The second insulating layer 522 is wrapped around an outer surface of the second feeding line 521. The second metal layer 523 is wrapped around an outer surface of the second insulating layer 522. The second insulating layer 522 having insulating properties electrically isolates the second feeding line 521 from the second metal layer 523.

The second feeding line 521 has one end connected to the second radiation portion 201 and the other end connected to the related circuit of the electronic device (not shown). The second metal layer 523 has one end connected to the second ground portion 203 and the other end connected to the ground of the related circuit of the electronic device (not shown).

The second feeding line 521 transmits an electrical signal corresponding to the electromagnetic wave received by the second radiation portion 201 to the related circuit of the electronic device, and then the related circuit of the electronic device transmits the electrical signal to the second radiation portion 201, such that the second radiation portion 201 converts the electrical signal and sends out the electromagnetic wave corresponding to the electrical signal.

Herein, the second coaxial cable 520 passes through the base plate 300 and penetrates the base plate 300 from between the third support portion 202 and the fourth support portion 204.

The second radiation portion 201 is defined with a protruding portion 201a. The protruding portion 201a extends from the second radiation portion 201, and a distal end of the protruding portion 201a is joined to the second feeding line 521 but spaced from the second metal layer 523 (i.e., without contacting the second metal layer 523). In other words, the protruding portion 201a is integrally and inseparably disposed on the second radiation portion 201 and has conductive properties, such that the second radiation portion 201 and the second feeding line 521 are electrically conducted through the protruding portion 201a.

The protruding portion 201a extends from the second radiation portion 201 in a direction towards the second ground portion 203, but is spaced from the same (i.e., without contacting the second ground portion 203).

That is, the protruding portion 201a does not contact the second metal layer 523 nor contact the second ground portion 203.

In addition, the second ground portion 203 may also be defined with a protruding portion 203a. The protruding portion 203a extends from the second ground portion 203, and the second ground portion 203 is joined to the second metal layer 523 but spaced from the second feeding line 521 (i.e., without contacting the second feeding line 521). In other words, the protruding portion 203a is integrally and inseparably disposed on the second ground portion 203 and has conductive properties, such that the second ground portion 203 and the second metal layer 523 are electrically conducted through the protruding portion 203a.

The protruding portion 203a extends from the second ground portion 203 in a direction towards the second radiation portion 201, but is spaced from the second radiation portion 201 (i.e., without contacting the second radiation portion 201).

That is, the protruding portion 203a does not contact the second feeding line 521 nor contact the second radiation portion 201.

For example, the dual-polarized antenna device of this embodiment may be electrically connected to various electronic devices. Electrical signals are sent out from the electronic devices, then transmitted to the first radiation portion 101 and the second radiation portion 201 through the first coaxial cable 500 and the second coaxial cable 520, and further transmitted out by the first polarized antenna 100 and the second polarized antenna 200 after being converted into electromagnetic waves. During the reception, the electromagnetic waves are received by the first polarized antenna 100 and the second polarized antenna 200, then converted into the electrical signals by the first radiation portion 101 and the second radiation portion 201, and further transmitted to the first coaxial cable 500 and the second coaxial cable 520. In this manner, the electrical signals are transmitted to the connected electronic devices, and the signal reception/transmission is thus completed.

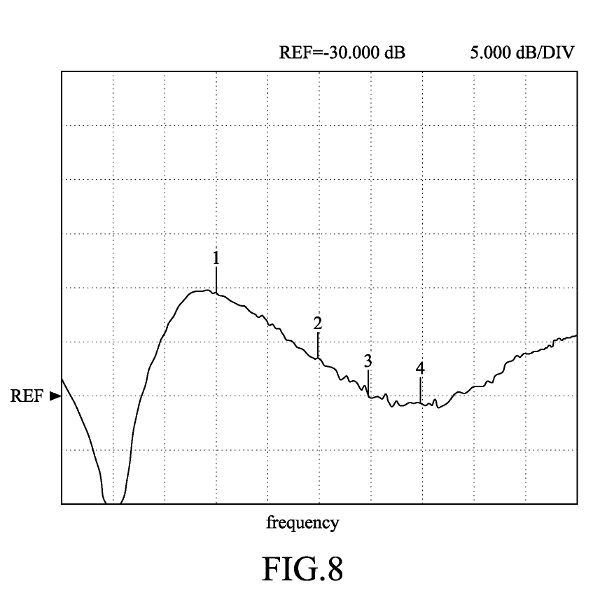

FIG. 8 is a curve diagram illustrating an isolation test between the first polarized antenna and the second polarized antenna shown in FIG. 5. Referring to FIG. 8, the vertical axis represents log values of energy with a unit of dB, the value of every division is 5 dB (5.00 dB/DIV), and the reference datum RDF is −30 dB. The horizontal axis represents a measured frequency range with a starting frequency of 2000 MHz and an ending frequency of 3000 MHz. Herein, the value of a test point 1 (having a frequency of about 2.3 GHz) is −20.506 dB, the value of a test point 2 (having a frequency of about 2.5 GHz) is −26.479 dB, the value of a test point 3 (having a frequency of about 2.6 GHz) is −29.882 dB, and the value of a test point 4 (having a frequency of about 2.7 GHz) is −30.770 dB.

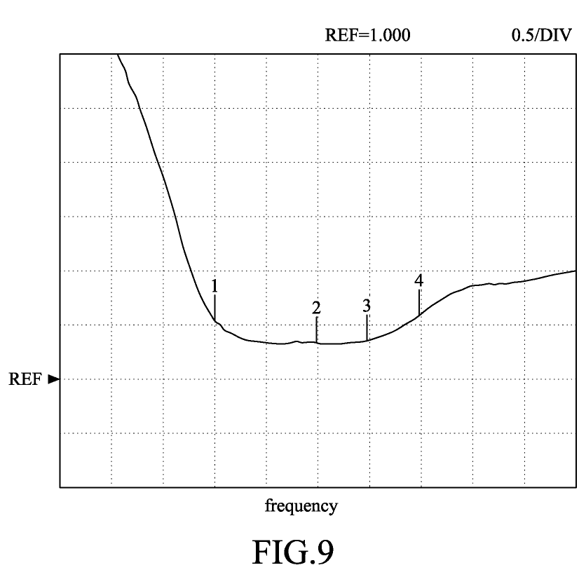

FIG. 9 is a curve diagram illustrating a test of a horizontal standing wave ratio (SWR) on the first polarized antenna shown in FIG. 5. Referring to FIG. 9, the vertical axis represents SWR values, the value of every division is 0.5 (0.5/DIV), and the reference datum REF is 1.000. The horizontal axis represents a measured frequency range with a starting frequency of 2000 MHz and an ending frequency of 3000 MHz. Herein, the value of a test point 1 (having a frequency of about 2.3 GHz) is 1.054, the value of a test point 2 (having a frequency of about 2.5 GHz) is 1.332, the value of a test point 3 (having a frequency of about 2.6 GHz) is 1.351, and the value of a test point 4 (having a frequency of about 2.7 GHz) is 1.575.

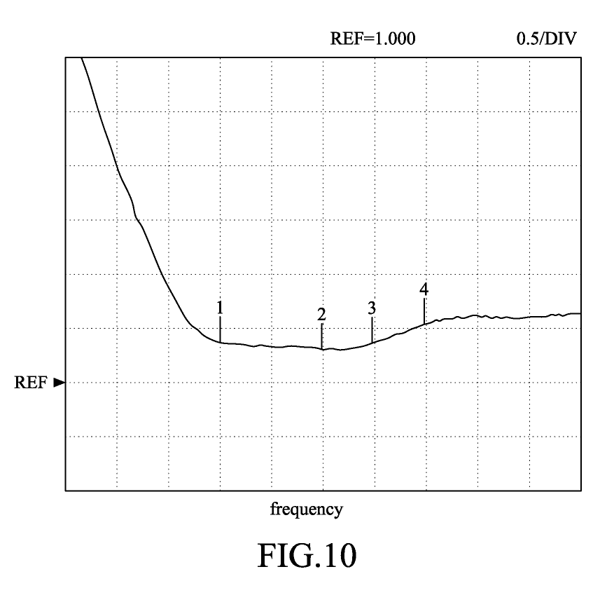

FIG. 10 is a curve diagram illustrating a test of a horizontal SWR on the second polarized antenna shown in FIG. 5. Referring to FIG. 10, the vertical axis represents SWR values, the value of every division is 0.5 (0.5/DIV), and the reference datum REF is 1.000. The horizontal axis represents a measured frequency range with a starting frequency of 2000 MHz and an ending frequency of 3000 MHz. Herein, the value of a test point 1 (having a frequency of about 2.3 GHz) is 1.372, the value of a test point 2 (having a frequency of about 2.5 GHz) is 1.311, the value of a test point 3 (having a frequency of about 2.6 GHz) is 1.350, and the value of a test point 4 (having a frequency of about 2.7 GHz) is 1.531.

After the first coaxial cable 500 of the antenna shown in FIG. 5 feeds a signal, the measured peak gains and half power beam widths (HPBWs) are shown in the following Table 1.

TABLE 1

| | | Frequency | | | | |
|---|---|---|---|---|---|---|
| First coaxial | | 2.3 | 2.4 | 2.5 | 2.6 | 2.7 |
| cable | Unit | GHz | GHz | GHz | GHz | GHz |
| Horizontal | dBi | 7.0 | 7.9 | 7.8 | 7.6 | 7.4 |
| peak gain | | | | | | |
| Vertical peak | dBi | 8.0 | 7.6 | 7.4 | 8.1 | 8.6 |
| gain | | | | | | |
| Horizontal | Degree | 72.7 | 64.0 | 63.0 | 67.6 | 69.8 |
| HPBW | | | | | | |
| Vertical | Degree | 62.8 | 66.9 | 65.2 | 65.4 | 63.3 |
| HPBW | | | | | | |

Moreover, after the second coaxial cable 520 of the antenna shown in FIG. 5 feeds a signal, the measured peak gains and HPBWs are shown in the following Table 2.

TABLE 2

| | | Frequency | | | | |
|---|---|---|---|---|---|---|
| | | 2.3 | 2.4 | 2.5 | 2.6 | 2.7 |
| Second coaxialcable | Unit | GHz | GHz | GHz | GHz | GHz |
| Vertical peak gain | dBi | 8.05 | 7.63 | 7.31 | 8.20 | 8.53 |
| Horizontal peak gain | dBi | 8.01 | 7.64 | 7.43 | 8.09 | 8.63 |
| Horizontal HPBW | Degree | 77.77 | 84.36 | 67.59 | 66.30 | 63.13 |
| Vertical HPBW | Degree | 62.81 | 669.2 | 65.19 | 63.38 | 63.28 |

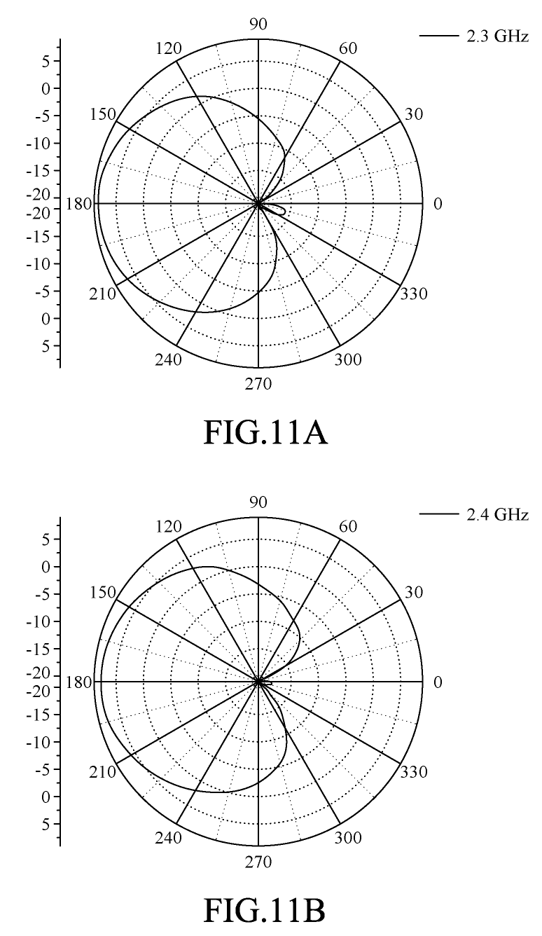

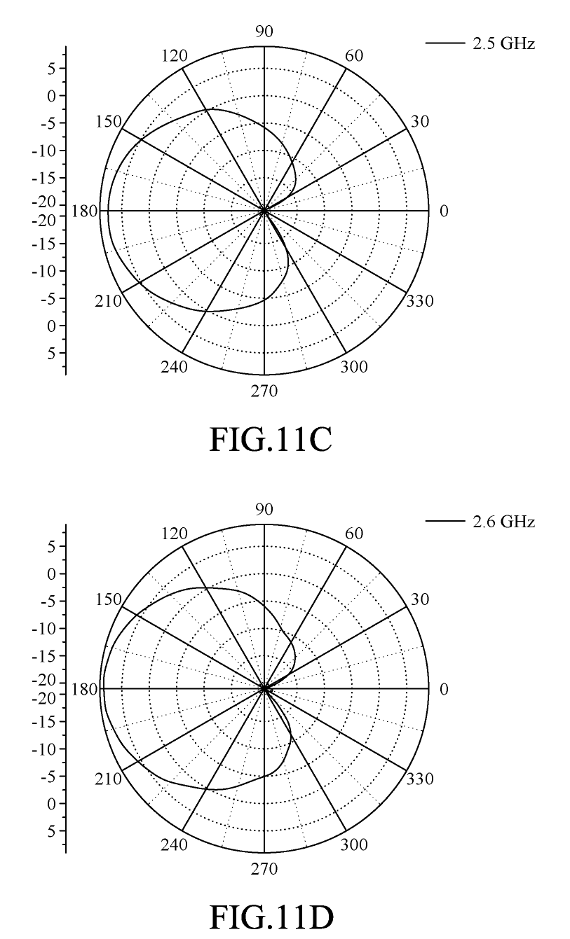

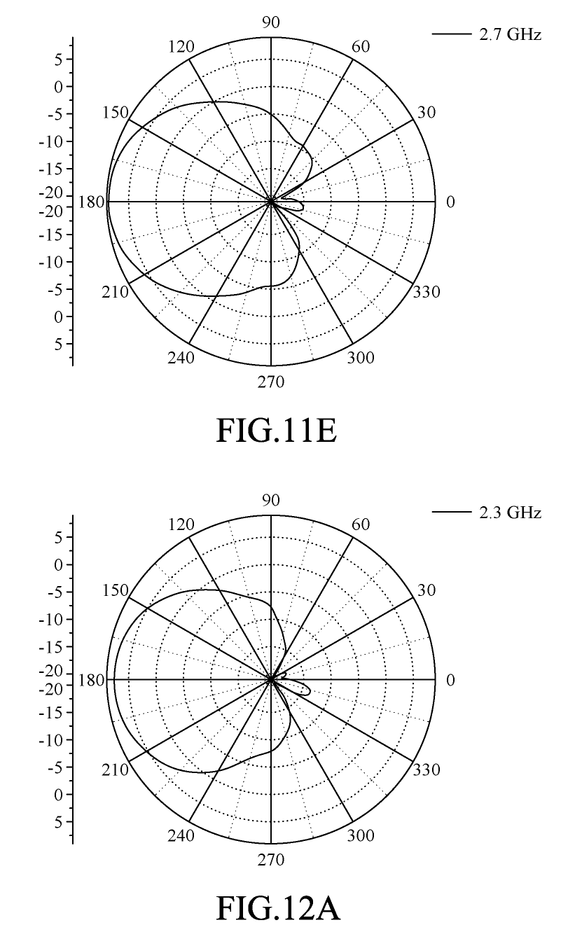

FIGS. 11A, 11B, 11C, 11D, and 11E are respectively radiation patterns of horizontal planes (H-planes) at measured frequencies of 2.3 GHz, 2.4 GHz, 2.5 GHz, 2.6 GHz, and 2.7 GHz after the second coaxial cable 520 of the antenna shown in FIG. 5 feeds the signal.

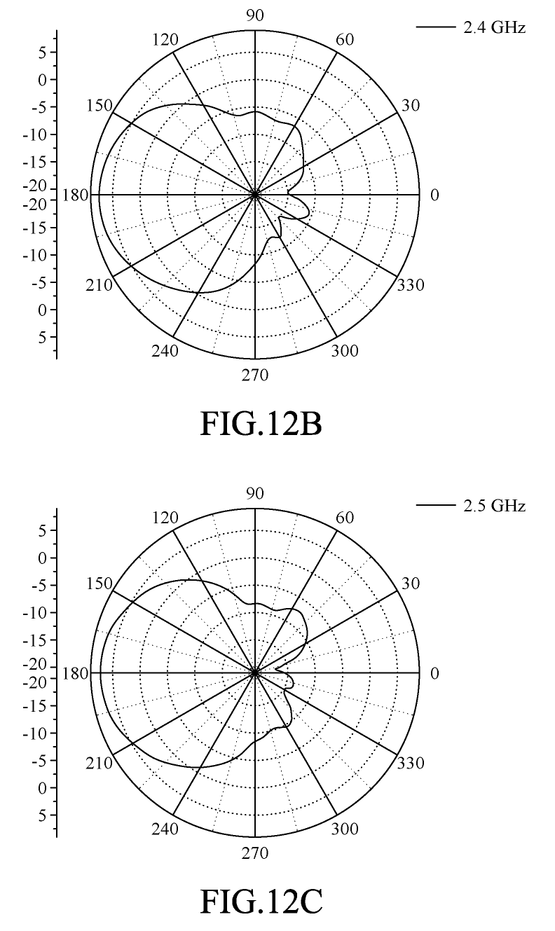

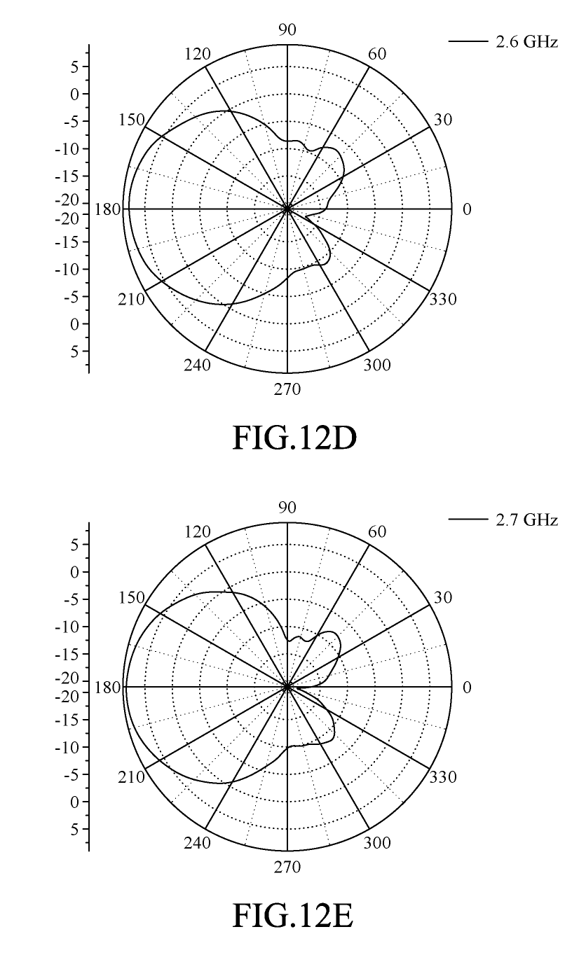

FIGS. 12A, 12B, 12C, 12D, and 12E are respectively radiation patterns of Vertical planes (V-planes) at measured frequencies of 2.3 GHz, 2.4 GHz, 2.5 GHz, 2.6 GHz, and 2.7 GHz after the second coaxial cable 520 of the antenna shown in FIG. 5 feeds the signal.

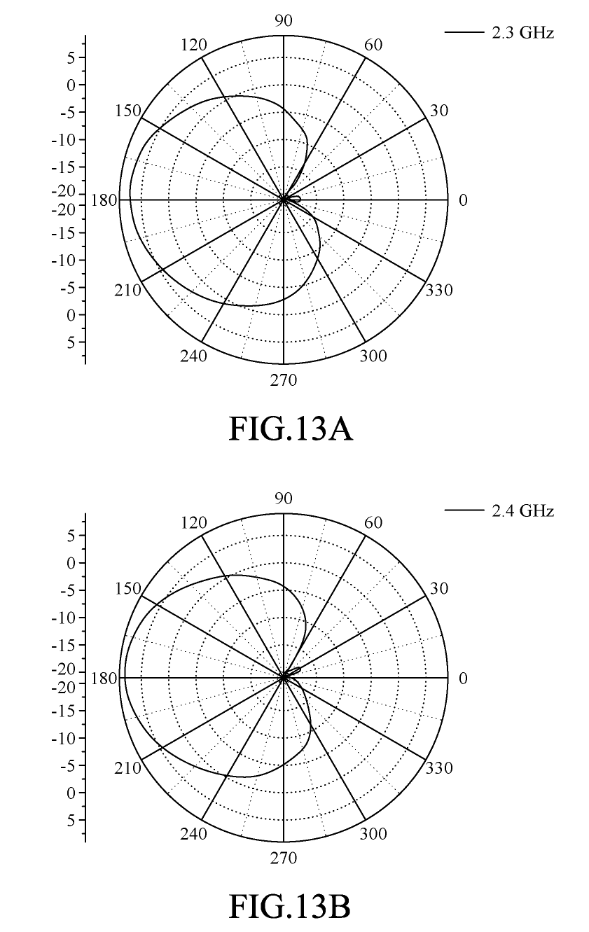

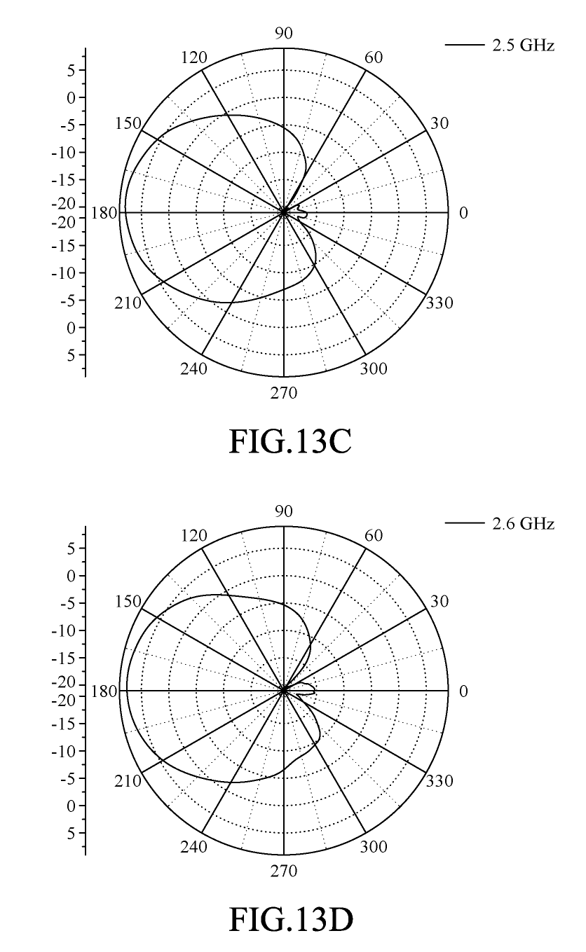

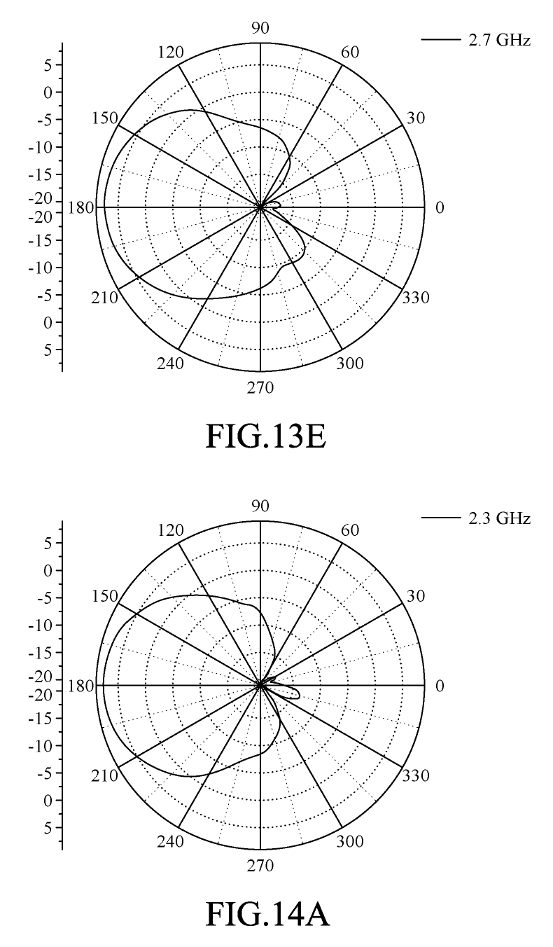

FIGS. 13A, 13B, 13C, 13D, and 13E are respectively radiation patterns of H-planes at measured frequencies of 2.3 GHz, 2.4 GHz, 2.5 GHz, 2.6 GHz, and 2.7 GHz after the first coaxial cable 500 of the antenna shown in FIG. 5 feeds the signal.

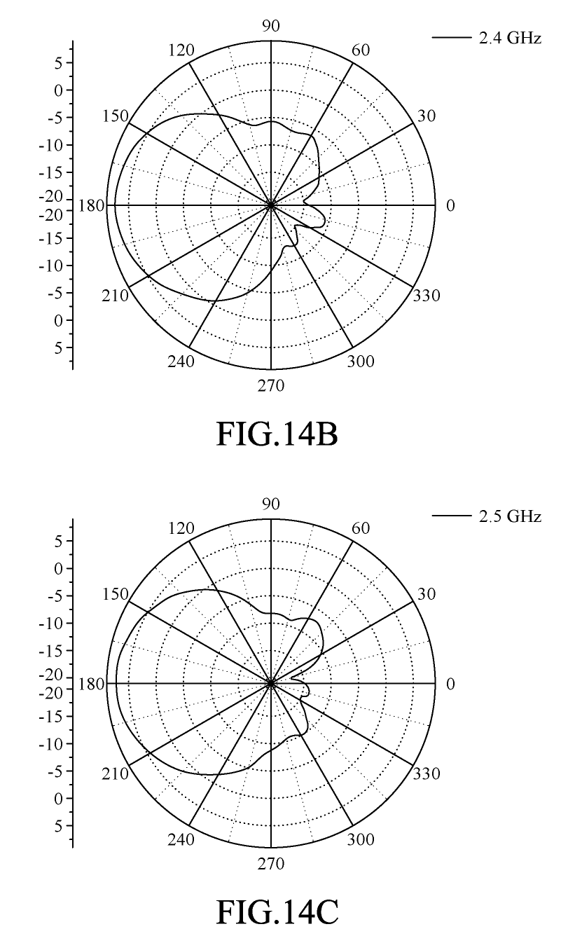

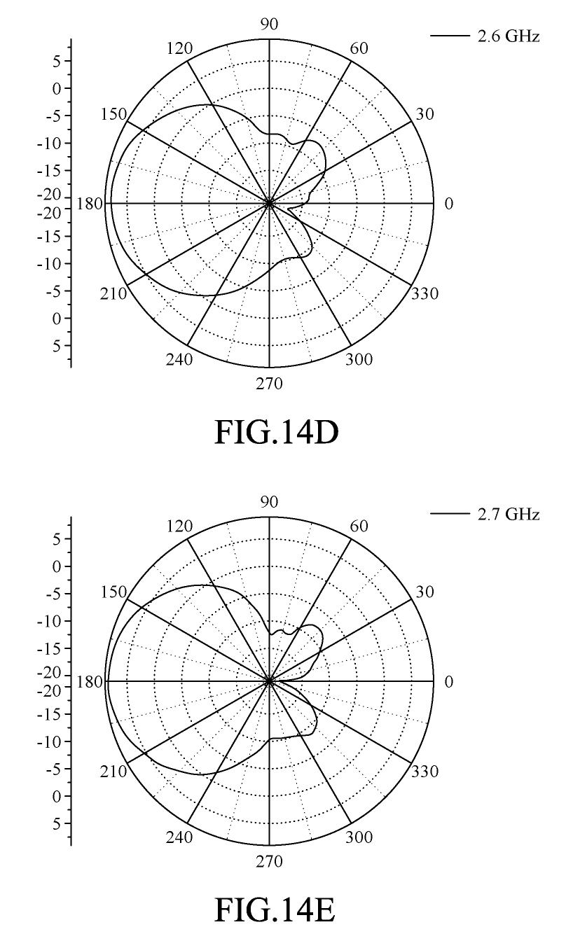

FIGS. 14A, 14B, 14C, 14D, and 14E are respectively radiation patterns of V-planes at measured frequencies of 2.3 GHz, 2.4 GHz, 2.5 GHz, 2.6 GHz, and 2.7 GHz after the first coaxial cable 500 of the antenna shown in FIG. 5 feeds the signal.

In view of the above, the dual-polarized antenna device of the present invention forms dual-polarization through the arrangement of the second polarized antenna perpendicularly crossing the first polarized antenna without contact, so as to effectively receive signals in different polarization directions. Further, through the respective integral and inseparable connections of the first polarized antenna 100 and the second polarized antenna 200 to the base plate 300, the dual-polarized antenna device of the present invention has a reduced cost and is more convenient to assemble.

What is claimed is:

1. A dual-polarized antenna device, comprising:
a base plate;
a first polarized antenna, comprising:
a first radiation portion, for receiving/transmitting an electromagnetic wave;
a first support portion, integrally and inseparably connected between the base plate and the first radiation portion, for supporting the first radiation portion;
a first ground portion, arranged with and extending along the first radiation portion, to be grounded; and
a second support portion, connected between the base plate and the first ground portion integrally and inseparably, for supporting the first ground portion; and
a second polarized antenna, arranged crossing the first polarized antenna without contact, comprising:
a second radiation portion, for receiving/transmitting the electromagnetic wave;
a third support portion, integrally and inseparably connected between the base plate and the second radiation portion, for supporting the second radiation portion;
a second ground portion, arranged with and extending along the second radiation portion, to be grounded; and
a fourth support portion, integrally and inseparably connected between the base plate and the second ground portion, for supporting the second ground portion.

2. The dual-polarized antenna device according to claim 1, further comprising a metal plate disposed on the face of the base plate opposite to the first polarized antenna and the second polarized antenna.

3. The dual-polarized antenna device according to claim 1, further comprising:
a first coaxial cable, penetrating the base plate, the cable comprising:
a first feeding line, connected to the first radiation portion, for transmitting an electrical signal corresponding to the electromagnetic wave;
a first insulating layer, having insulating properties, and wrapped around the first feeding line; and
a first metal layer, wrapped around the first insulating layer, and connected to the first ground portion; and
a second coaxial cable, penetrating the base plate, the cable comprising:
a second feeding line, connected to the second radiation portion, for transmitting the electrical signal corresponding to the electromagnetic wave;
a second insulating layer, having insulating properties, and wrapped around the second feeding line; and
a second metal layer, wrapped around the second insulating layer, and connected to the second ground portion.

4. The dual-polarized antenna device according to claim 1, wherein a surface of the first radiation portion extends to intersect with a surface of the base plate, and a surface of the first ground portion extends to intersect with the surface of the base plate.

5. The dual-polarized antenna device according to claim 1, wherein a surface of the second radiation portion extends to intersect with the surface of the base plate, and a surface of the second ground portion extends to intersect with the surface of the base plate.

6. The dual-polarized antenna device according to claim 1, wherein the base plate has a first through-hole located between the first support portion and the second support portion and a second through-hole located between the third support portion and the fourth support portion.

7. The dual-polarized antenna device according to claim 6, further comprising:
a first coaxial cable, electrically connected to the first radiation portion and the first ground portion through the first through-hole; and
a second coaxial cable, electrically connected to the second radiation portion and the second ground portion through the second through-hole.
